(19) United States
(12) Patent Application Publication
(10) Pub. No.: US 2009/0073250 A1
(43) Pub. Date: Mar. 19, 2009

(54) THERMAL PRINTHEAD

(75) Inventors: Masatoshi Nakanishi, Kyoto-shi (JP); Shinobu Obata, Kyoto-shi (JP)

Correspondence Address: HAMRE, SCHUMANN, MUELLER & LARSON, P.C., P.O. BOX 2902, MINNEAPOLIS, MN, 55402-0902, US

(73) Assignee: ROHM CO., LTD., Kyoto-shi (JP)

(21) Appl. No.: 12/270,288

(22) Filed: Nov. 13, 2008

Related U.S. Application Data
(63) Continuation of application No. 10/589,586, filed on Aug. 16, 2006.

(30) Foreign Application Priority Data
Feb. 19, 2004 (JP) 2004-042581

(51) Int. Cl. B41J 2/35

(52) U.S. Cl. 347/211

(57) ABSTRACT

In a thermal printhead (A), a common wiring portion (4) is divided into a plurality of blocks (BL) arranged side by side in a primary scanning direction, and voltage is applied to opposite ends of each of the blocks (BL) in the primary scanning direction. A plurality of heating resistance sections (3) are divided into a plurality of blocks (BL′) corresponding to the blocks (BL) of the common wiring portion (4), and in each of the blocks (BL′), the resistance reduces as proceeding from opposite ends toward the center in the primary scanning direction. Therefore, the adjustment of the resistances of the plurality of heating resistance sections is easy, and the non-uniformity in darkness of print dots is reduced, so that high-quality image printing is possible.

### CROSS REFERENCE TO RELATED APPLICATIONS

This application is a Continuation of U.S. Ser. No. 10/589,586, filed Aug. 16, 2006 which is incorporated herein by reference.

### TECHNICAL FIELD

The present invention relates to a thermal printhead used as a structural part of a thermal printer. More particularly, the present invention relates to a thermal printhead capable of making a plurality of print dots printed on a recording medium uniform in darkness.

### BACKGROUND ART

An example of conventional thermal printhead is schematically shown in FIG. 6(a). The illustrated thermal printhead B includes a substrate 90 on which are provided a plurality of heating resistance sections 91 arranged side by side in the primary scanning direction (horizontal direction in the figure) and a common wiring portion 92 including a straight portion 92a extending in the primary scanning direction. One end of each of the heating resistance sections 91 is connected to the common wiring portion 92 via a first lead wiring portion 93A. Another end of each heating resistance section 91 is connected to a drive IC 94 via a second lead wiring portion 93B and a wire W. Voltage is applied to opposite ends 92b of the common wiring portion 92. By the switching control of the drive ICs 94, selected ones of the heating resistance sections 91 are energized to produce heat. By the heat production, an image is printed on thermal recording paper, for example.

To enhance the quality of the print image, the non-uniformity in darkness of the print dots printed by the plurality of heating resistance sections 91 needs to be reduced. For this purpose, the resistances of the heating resistance sections 91 may be set to be generally equal. However, since the straight portion 92a of the common wiring portion 92 is relatively long, voltage drop occurs at the straight portion 92a. The amount of voltage drop is large at or near the center of the straight portion 92a in the longitudinal direction. Due to the voltage drop, the amount of electric energy supplied to each the heating resistance sections 91 becomes unequal, which causes non-uniformity in darkness of the print dots.

A conventional countermeasure against such a problem is disclosed in Patent Document 1. In the disclosed structure, instead of making the resistances of the plurality of heating resistance sections 91 equal, the resistances of the heating resistance sections 91 are adjusted to reduce as proceeding toward the center in the primary scanning direction, as shown in FIG. 6(b). With such a structure, the resistance of the heating resistance section 91 is low at a portion where the amount of voltage drop at the common wiring portion 92 is large. Therefore, the electric energy supplied to the plurality of heating resistance sections 91 can be made generally equal.

However, the above-described conventional structure still has room for improvement.

Specifically, the difference R between the resistance of the heating resistance section 91 positioned at an end and that of the heating resistance section positioned at the center in the primary scanning direction corresponds to the maximum voltage drop at the straight portion 92a of the common wiring portion 92, and the value is large. Particularly, when the common wiring portion 92 has a small cross section and hence has a high resistance or when the common wiring portion 92 is made long to increase the size of the thermal printhead B, the resistance difference R becomes larger. Therefore, the degree of adjustment of the resistances of the heating resistance sections 91 is large. Therefore, when the resistances are to be adjusted by trimming, the amount of trimming necessary for the resistance adjustment is large. Therefore, the operation takes long time and is inefficient.

To make the gradation level or size of print dots uniform and enhance the quality of a printed image, it is required to make the heating resistance sections 91 as uniform as possible in structure and heating conditions. This is particularly required for color printing, because, in the case of color printing, higher image quality is demanded than in monochrome printing. However, in the conventional structure, the resistances of the heating resistance sections 91 are so adjusted as to provide a large variation. Therefore, the above-described requirement is not fulfilled, and there is still room for improvement of the print image quality.

Patent Document 1: JP-A-H06-71922

### DISCLOSURE OF THE INVENTION

An object of the present invention, which is conceived under the above-described circumstances, is to provide a thermal printhead which is capable of facilitating the operation to adjust the resistances of a plurality of heating resistance sections, reducing non-uniformity in darkness of print dots and printing a high-quality image.

According to a first aspect of the present invention, there is provided a thermal printhead comprising a plurality of heating resistance sections arranged on a substrate side by side in a primary scanning direction, a common wiring portion at least part of which extends in the primary scanning direction while being spaced from the heating resistance sections in a secondary scanning direction, and a plurality of first lead wiring portions and a plurality of second lead wiring portions for connecting the heating resistance sections to the common wiring portion and to a drive IC for controlling energization. The common wiring portion is segmented into a plurality of blocks arranged side by side in the primary scanning direction, and voltage is applied to opposite ends of each of the blocks in the primary scanning direction. The plurality of heating resistance sections are segmented into a plurality of other blocks corresponding to the blocks of the common wiring portion, and, in each of the above-mentioned other blocks, resistance of the heating resistance sections reduces as proceeding from opposite ends toward the center of the block in the primary scanning direction.

Preferably, the plurality of first lead wiring portions are generally equal to each other in resistance, and the plurality of second lead wiring portions are generally equal to each other in resistance.

Preferably, the first lead wiring portions are unequal in length, and the second lead wiring portions are unequal in length. A longer one of the lead wiring portions has a larger width at least partially.

Preferably, a plurality of drive ICs are provided, and each of the drive ICs corresponds to a respective one of the above-mentioned other blocks of the heating resistance sections.

Preferably, the thermal printhead further comprises a plurality of third lead wiring portions each connecting adjacent pair of the heating resistance sections arranged in the primary scanning direction. The drive IC is arranged closer to the common wiring portion than to the heating resistance sections in the secondary scanning direction. The first lead wiring portions and the second lead wiring portions are alternately arranged in the primary scanning direction to be connected to respective pairs of the heating resistance sections and extend from the heating resistance sections toward the common wiring portion.

Other features and advantages of the present invention will become more apparent from the following description of embodiments of the invention.

### BRIEF DESCRIPTION OF THE DRAWINGS

FIG. 1 is a schematic plan view showing a thermal printhead according to an embodiment of the present invention.

FIG. 2 is a plan view showing the principal portion of FIG. 1.

FIG. 3 is a sectional view taken along lines III-III in FIG. 1.

FIG. 4 is a sectional view showing the principal portion of the thermal printhead shown in FIG. 1.

FIG. 5 is a graph showing the resistances of the plurality of heating resistance sections.

FIG. 6(a) is a schematic plan view showing an example of conventional structure, whereas FIG. 6(b) is a graph showing the resistances of the plurality of heating resistance sections in the conventional structure shown in FIG. 6(a).

### BEST MODE FOR CARRYING OUT THE INVENTION

Preferred embodiments of the present invention will be described below in detail with reference to the accompanying drawings.

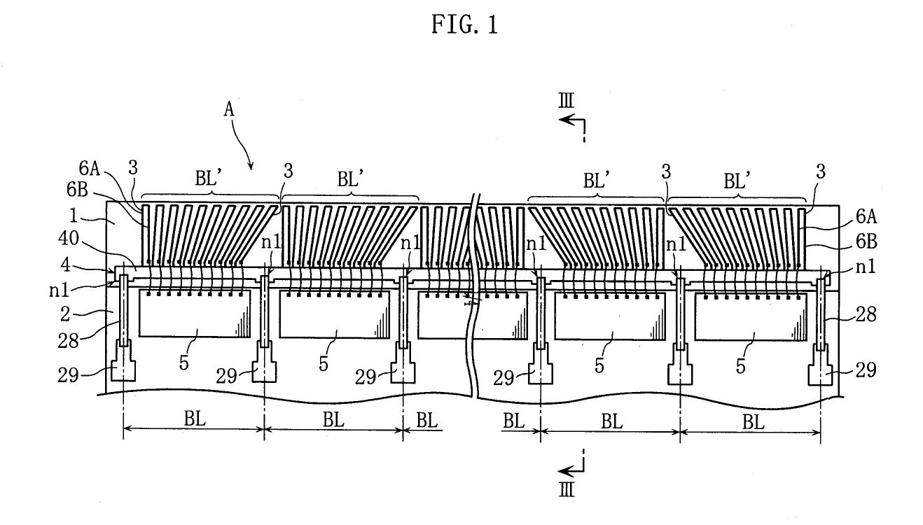

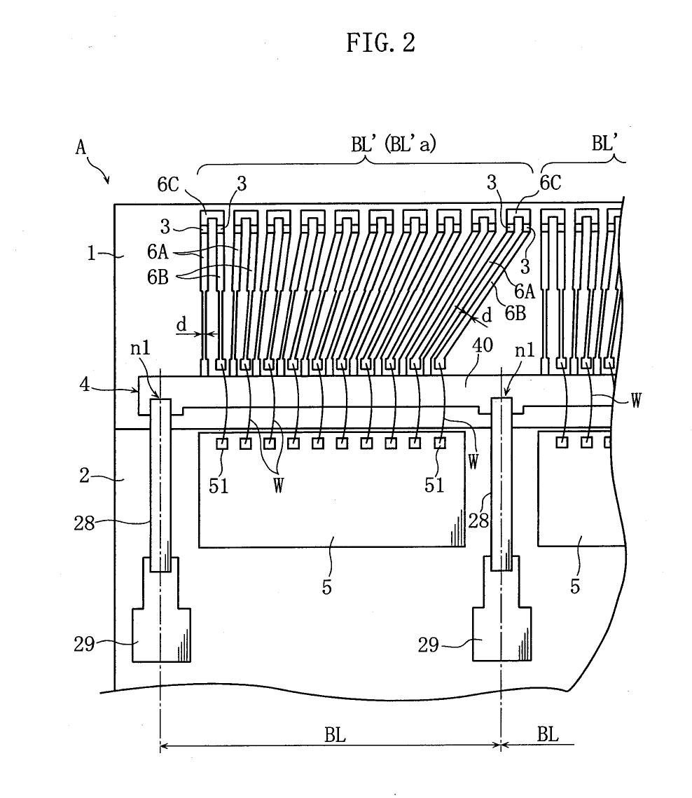

FIGS. 1-4 show an embodiment of thermal printhead according to the present invention. As shown in FIGS. 1 and 2, the thermal printhead A in this embodiment includes a head substrate 1, a printed board 2, a plurality of heating resistance sections 3, a common wiring portion 4, a first through a third lead wiring portions 6A-6C, and a plurality of drive ICs 5.

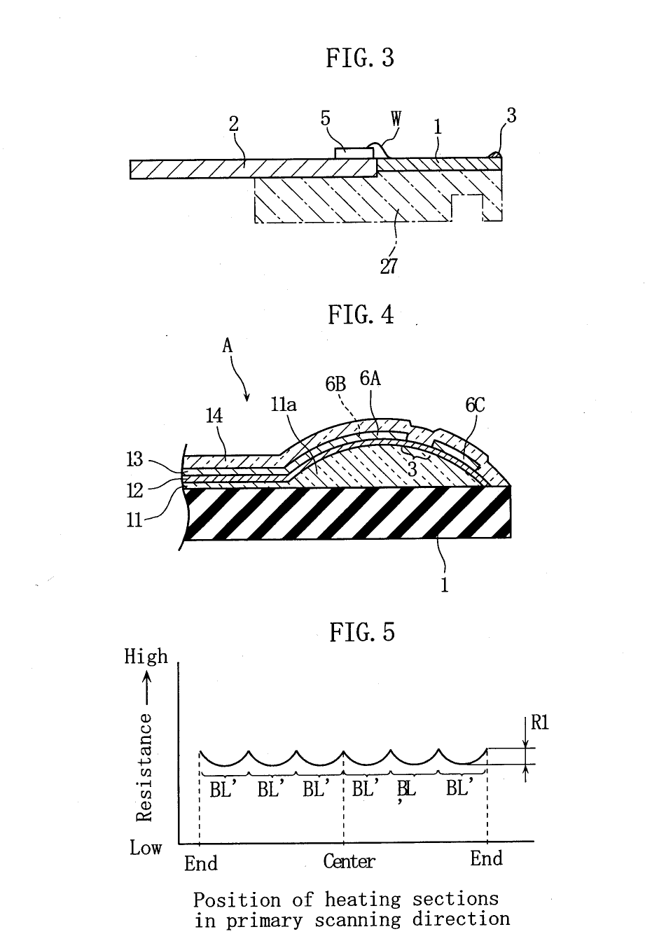

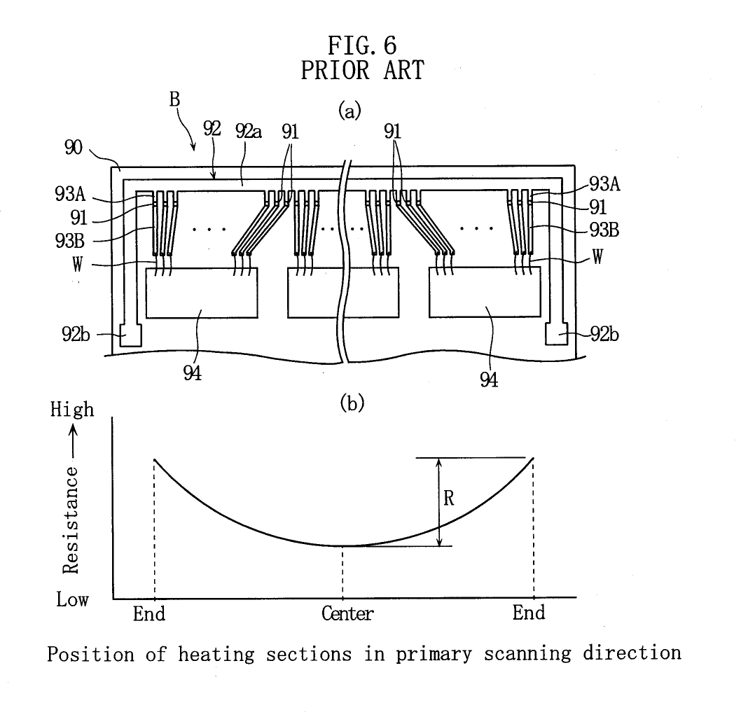

Both of the head substrate 1 and the printed board 2 comprise a flat insulating plate in the form of an elongated rectangle in plan view. The head substrate 1 may be made of alumina ceramic, for example. The printed board 2 may be made of glass-fiber-reinforced epoxy resin, for example. As shown in FIG. 3, the head substrate 1 and the printed board 2 are supported by a supporting member 27 made of metal and are arranged side by side in the width direction thereof (corresponding to the secondary scanning direction).

As shown in FIG. 4, a glaze layer 11, a heating resistor layer 12, a conductive layer 13 for electrodes, and a protective layer 14 are laminated one upon another on the head substrate 1. The glaze layer 11 is formed by printing and baking glass paste and includes a bulging portion 11a having an obverse surface which is arcuate in cross section. The bulging portion 11a is positioned on or near an edge of the head substrate 1. The heating resistor layer 12 is made by forming a film of TaSiO₂ by CVD or sputtering. The conductive layer 13 for electrodes is made by forming a film of metal having an excellent conductivity such as Al by sputtering. By patterning the conductive layer 13 by e.g. photolithography, the first through the third lead wiring portions 6A-6C and the common wiring portion 4 are provided. Each of the first through the third lead wiring portions 6A-6C and the common wiring portion 4 serves as an electrode. On or near the top of the bulging portion 11a, the first and the second lead wiring portions 6A, 6B are arranged to be spaced from the third lead wiring portions 6C so as to expose portions of the heating resistor layer 12 therebetween. The exposed portions of the heating resistor layer 12 are the heating resistance sections 3. For instance, the protective layer 14 may be formed by CVD or sputtering, and the material may be TA₂O₅ or Si₃N₄.

As shown in FIG. 2, the plurality of heating resistance sections 3 are provided on or near a longitudinally-extending edge (extending in the primary scanning direction) of the head substrate 1 and spaced from each other in the primary scanning direction by a predetermined distance. The common wiring portion 4 includes a straight portion 40 extending in the primary scanning direction on or near the opposite longitudinally-extending edge of the head substrate. Although detailed description will be given later, the straight portion 40 is divided into a plurality of blocks BL in the primary scanning direction. The plurality of heating resistance sections 3 are divided into a plurality of blocks BL′ in the primary scanning direction. The blocks BL and the blocks BL′ are in one-to-one correspondence. Each of the blocks BL′ corresponds to a respective one of the drive ICs 5.

The first lead wiring portions 6A and the second lead wiring portions 6B are alternately arranged in the primary scanning direction. The first lead wiring portions 6A electrically connect the heating resistance sections 3 to the straight portion 40 of the common wiring portion 4. Each of the second lead wiring portions 6B has a first end electrically connected to the heating resistance section 3 and a second end positioned close to but spaced from the common wiring portion 4. The second end of each lead wiring portion 6B is connected to an electrode 51 of the drive IC 5 via a wire W so that short-circuiting does not occur between the second end and the common wiring portion 4. The drive ICs 5 serve to control energization of each of the heating resistance sections 3 based on print image data transmitted from outside and are mounted on the printed board 2. As the drive ICs 5, conventionally-known drive ICs can be used. Each of the third lead wiring portions 6C is channel-shaped in plan view and electrically connects two adjacent ones of the heating resistance sections 3 to each other.

Of the plurality of first and second lead wiring portions 6A and 6B, the portions adjacent to the heating resistance sections 3 are equal to each other in width, whereas the portions adjacent to the common wiring portion 4 are unequal in width d. By making the widths d unequal, the resistances of the first wiring portions 6A are made generally equal to each other, and the resistances of the second lead wiring portions 6B are made generally equal to each other. Specifically, the pitch between adjacent ends of the first and the second lead wiring portions 6A, 6B adjacent to the common wiring portion 4 is smaller than the pitch between adjacent heating resistance sections 3. Therefore, the lengths of the first and the second lead wiring portions 6A, 6B are unequal. For instance, in the first and the second lead wiring portions 6A, 6B of the first block BL′ (BL′a) shown in FIG. 2, the first and the second lead wiring portions 6A, 6B become longer as proceeding toward the right in the figure. On the other hand, the width d of the portions of the first and the second lead wiring portions 6A, 6B adjacent to the common wiring portion 4 increases as proceeding toward the right in the figure. With such a structure, respective resistances of the first lead wiring portions 6A are generally equal, and respective resistances of the second lead wiring portions 6B are generally equal. The plurality of third lead wiring portions 6C are equal to each other in shape and size, so that respective resistances thereof are generally equal. Such a structure holds true for other blocks BL′, which is advantageous for enhancing the quality of print image, which will be described later.

As noted before, the straight portion 40 of the common wiring portion 4 is divided into a plurality of blocks BL. The plurality of blocks BL are generally equal to each other in length in the primary scanning direction. A plurality of pads 29 are provided on the printed board 2. The pads 29 are spaced from each other in the primary scanning direction. The pads 29 are connected to opposite ends (indicated by reference sign n1) of the straight portion 40 of each block BL via a plurality of jumpers 28. Thus, voltage can be simultaneously applied, via the pads 29, to a plurality of portions corresponding to opposite ends of each block BL in the primary scanning direction.

The resistances of the plurality of heating resistance sections 3 are adjusted by trimming. Specifically, the resistances of the heating resistance sections 3 are adjusted to reduce as proceeding from opposite ends toward the center in each block BL′ to draw a quadratic curve as shown in FIG. 5. For instance, such adjustment of resistances is performed as follows. First, before performing the adjustment of resistances, test printing of an image on recording paper is performed by causing the plurality of heating resistance sections 3 to actually produce heat. Subsequently, the printed image is read by using a scanner to analyze the non-uniformity in the darkness of the print dots. For instance, when the heating resistance sections 3 are generally equal to each other in resistance, the darkness of the print dots of the print image reduces as proceeding from the opposite ends toward the center of each block BL′ in the primary scanning direction due to the voltage drop in the common wiring portion 4. Such non-uniformity in darkness can be grasped as difference in gradation level in the image read by using a scanner. The amount of correction of the resistance for eliminating the difference in gradation level is determined with respect to the heating resistance sections 3 and trimming for the correction is performed. Since the gradation levels of a printed image and the resistances of the heating resistance sections 3 are in a fixed relationship, the correction amount of the resistances of the heating resistance sections 3 can be accurately determined based on the difference in gradation level in the printed image.

The operation and advantages of the thermal printhead A will be described below.

To print an image on recording paper, voltage is applied to each of the pads 29. Selected ones of the heating resistance sections 3 are energized under the control of the drive ICs 5. In this case, the voltage application to the straight portions 40 of the common wiring portion 4 is performed with respect to each of the blocks BL. Therefore, the voltage drop due to the electrical resistance of the straight portion 40 occurs individually in each of the blocks BL, and the amount of voltage drop increases as proceeding toward the center of the block BL in the primary scanning direction. On the other hand, in the thermal printhead A, adjustment of resistance is so performed that, in each of the blocks BL′, the resistance of the heating resistance sections 3 reduces as proceeding toward the center of the block in the primary scanning direction. With such a structure, an equal amount of heat can be produced at each of the heating resistance sections 3, so that conspicuous non-uniformity in darkness of the print dots can be prevented. Particularly, in this embodiment, the trimming of the heating resistance sections 3 is performed based on the non-uniformity in darkness of the actually printed dots to provide resistances which can eliminate the non-uniformity. Therefore, non-uniformity in darkness of the print dots is further reduced.

The common wiring portion 4 is divided into a plurality of blocks BL, and voltage application is performed with respect to each of the blocks BL. Therefore, the amount of voltage drop in each of the blocks BL is small. Therefore, as shown in FIG. 5, the difference R1 between the maximum resistance and the minimum resistance of the heating resistance sections 3 can be made small. As a result, the amount of trimming which needs to be performed with respect to the heating resistance sections 3 is relatively small, which facilitates the trimming operation. Further, when the variation in resistances of the heating resistance sections 3 is small, heat-producing conditions of the heating resistance sections 3 is uniform. Therefore, not only the darkness but also the size of the printing dots can be made uniform. Therefore, the thermal printhead A can provide a high-quality printed image.

In the thermal printhead A, the resistances are equal among the first lead wiring portions 6A, among the second lead wiring portions 6B and among the third lead wiring portions 6C. Therefore, the electric power supplied to respective heating resistance sections 3 does not differ largely. When the resistances of the heating resistance sections 3 are adjusted based on the gradation levels of a test print image, the amount of heat production at the respective heating resistance sections 3 can be made equal with the variations in resistance of the first through the third lead wiring portions 6A-6C taken into account. In this case, when the variations in resistance of the first through the third lead wiring portions 6A-6C are eliminated, the adjustment of the resistances of the heating resistance sections 3 becomes easy.

As shown in FIG. 5, the adjustment or setting of the resistances of the heating resistance sections 3 is performed in the same way in each of the blocks BL′, and each block BL′ corresponds to a single drive IC 5. Further, with respect to the first and the second lead wiring portions 6A, 6B, a predetermined wiring pattern is repeated for each of the drive ICs 5. Therefore, the patterns of the heating resistance sections 3 and the first and the second lead wiring portions 6A, 6B are simple. Therefore, the heating resistance sections 3 and the first and the second lead wiring portions 6A, 6B can be formed easily. Further, the thermal printhead A has a so-called near-edge structure, i.e., the heating resistance sections 3 are provided at or near an edge of the head substrate 1. Therefore, as a platen roller for pressing recording paper against the heating resistance sections 3, a large one can be used easily.

The present invention is not limited to the foregoing embodiments. The specific structure of each part of the thermal printhead may be varied in many ways without departing from the spirit of the present invention.

The blocks of the drive ICs and those of the heating resistance sections may not be in one-to-one correspondence. It is only necessary that the heating resistance sections are divided into a plurality of blocks corresponding to the dividing of the common wiring portion into blocks. With respect to the common wiring portion, it is only necessary that the common wiring portion is divided into a plurality of blocks, and the number of blocks may be varied. However, it is desirable that the dimension of the region of each block of the common wiring portion is small to reduce the voltage drop at the common wiring portion. To reduce the voltage drop at the common wiring portion, it is preferable that the common wiring portion is divided into as large number of blocks as possible. Further, considering the ease of manufacturing, it is preferable that the common wiring portion is divided into the same number of blocks as the drive ICs.

In the present invention, the means for adjusting the resistances of the heating resistance sections is not limitative. With respect to the resistances of the heating resistance sections, it is only necessary that the resistance reduces as proceeding from opposite ends toward the center in the primary scanning direction in each of the blocks of the heating resistance sections. In the present invention, the pattern shape of the common wiring portion and the first and the second lead wiring portions is not limitative. In the thermal printhead according to present invention, the common wiring portion and the first lead wiring portions may be formed as a so-called comb-shaped electrode. Moreover, the present invention is applicable to both of a thick-film thermal printhead and a thin-film thermal printhead.

1-5. (canceled)

6. A method of adjusting a thermal printhead, the printhead comprising:
a plurality of heating resistance sections arranged on a substrate side by side in a primary scanning direction;
a common wiring portion at least part of which extends in the primary scanning direction while being spaced from the heating resistance sections in a secondary scanning direction;
a plurality of first lead wiring portions and a plurality of second lead wiring portions for connecting the heating resistance sections to the common wiring portion and to a plurality of drive ICs for controlling energization;
the common wiring portion is segmented into a plurality of blocks arranged side by side in the primary scanning direction in corresponding relationship to the plurality of drive ICs, a voltage being applied to opposite ends of each of the blocks in the primary scanning direction; and
the plurality of heating resistance sections are segmented into a plurality of other blocks corresponding to the blocks of the common wiring portion, resistance of the heating resistance sections in each of said other blocks, reduces as proceeding from the opposite ends of the block toward center of the block in the primary scanning direction;
the method comprising:
test-printing an image on recording paper by causing the plurality of heating resistance sections to actually generate heat, the image being formed by a plurality of print dots;
causing a scanner to read the printed image for determining difference in gradation level between the print dots; and
adjusting the resistance of the plurality of heating resistance sections by trimming for eliminating the difference in gradation level between the print dots.

7. The method according to claim 6, wherein the plurality of first lead wiring portions are generally equal to each other in resistance, and the plurality of second lead wiring portions are generally equal to each other in resistance.

8. The method according to claim 7, wherein the first lead wiring portions are unequal in length, and the second lead wiring portions are unequal in length, wherein a longer one of the lead wiring portions has a larger width at least partially.

9. The method according to claim 6, wherein a plurality of drive ICs are provided, and each of the drive ICs corresponds to a respective one of said other blocks of the heating resistance sections.

10. The method according to claim 6, further comprising a plurality of third lead wiring portions each connecting adjacent pair of the heating resistance sections arranged in the primary scanning direction;
wherein the drive IC is arranged closer to the common wiring portion than to the heating resistance sections in the secondary scanning direction; and
wherein the first lead wiring portions and the second lead wiring portions are alternately arranged in the primary scanning direction to be connected to respective pairs of the heating resistance sections and extend from the heating resistance sections toward the common wiring portion.
